(19) United States
(12) Patent Application Publication
(10) Pub. No.: US 2014/0008833 A1
(43) Pub. Date: Jan. 9, 2014

(54) Non ionic groups of amphoteric polysaccharide linear or branched alkyl or acid and base distillation reservoir liquid or gas solids particle and Nano particle dispersion and recovery basin in vacuum processing for Building Materials and High Wear-Heat Resistant Parts Brushes; Windings; Coils; Battery Cells; Brake Pads; Bushings; And 2.5 Phase Extrusion Die Cast Molding

(71) Applicant: Robert Richard Matthews, Washington, DC (US)

(72) Inventor: Robert Richard Matthews, Washington, DC (US)

(21) Appl. No.: 13/546,990

(22) Filed: Jul. 11, 2012

Related U.S. Application Data
(63) Continuation-in-part of application No. 13/544,938, filed on Jul. 9, 2012, now abandoned.

(51) Int. Cl. B29C 67/20

(52) U.S. Cl. 264/41; 425/4 R; 977/842

(57) ABSTRACT

The variable hydraulic preform slurry electrolyte carbon extrusion high wear-heat resistant parts press is utilized process specified scientific formula liquid or gas Nano particle dispersion preform slurry electrolyte extrusion carbon nanofoam CNFs, with or without ionic suspension element 1. preform slurry electrolyte carbon nanofoam CNFs extrusion high wear-heat resistant parts electronic component composite coils, composite windings, brushes, inductors, antinode couplers, electric rheostats, starters, motors, alternators, generators, ionic suspension element enhanced composite coils, composite windings, brushes, capacitors, battery cells, rheostats, electronic resistors, transformers, transducers, rectifiers, power supplies, or heat sinks 2. Preform slurry electrolyte carbon nanofoam CNFs extrusion high wear-heat resistant parts aerospace, automotive, and transportation brake calipers, rotors, pads, and bushings 3. Preform slurry electrolyte carbon nanofoam CNFs extrusion high wear-heat resistant parts precision casting molds for the manufacturing of highly pure metal, super alloy, acid solid, alkaline, halide, alkalide, or ceramics specializing in 2.5 phase die cast.

### DOMESTIC PRIORITY DATA

This is an application a continuation in part of preliminary amendment to specification application Ser. No. 13/544,938 Filing Date Jul. 9, 2012.

### BACKGROUND OF THE INVENTION

Global warming and growing concerns of Greenhouse gas emissions from our dependency on fossil fuels are creating real demand and awareness for an electric alternative to fossil fuel engines and expensive replacement parts. Few technological developments of collecting and manufacturing carbon nanofoam CNFs improve upon our existing technological structure. By applying scientific utilization of preform technology the variable hydraulic preform slurry non ionic or electrolyte carbon nanofoam CNFs extrusion high wear-heat resistant parts press with manufactured or processed carbon nanofoam CNFs assembled resources, we can now create the manufacture process of preform slurry non ionic or electrolyte carbon nanofoam CNFs extrusion high wear-heat resistant parts.

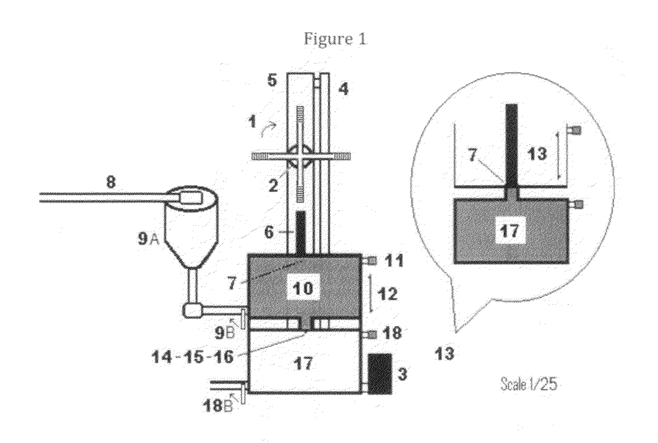

### BRIEF DESCRIPTION OF FIG. 1

FIG. 1 the variable hydraulic preform slurry non ionic or electrolyte carbon nanofoam CNFs extrusion high wear-heat resistant parts press.

### DETAILED DESCRIPTION OF FIG. 1

Variable hydraulic preform slurry non ionic or electrolyte carbon extrusion high wear-heat resistant parts press 1-Hydraulic control wheel 2-Electronic servo 3-Hydraulic pump 4-Hydraulic pipe 5-Hydraulic actuator 6-Hydraulic tool steel arm 7-Slurry carbon tool steel press plate 8-Slurry carbon tool steel line in 9A-Gravity feed tool steel collector 9B-Tool steel release portal control 10-Slurry carbon tool steel reservoir 11-Slurry carbon reservoir regulated tool steel waste filter 12-Slurry carbon tool steel reservoir expanded 13-Slurry carbon tool steel reservoir contracted 14-Slurry carbon reservoir brass-tool steel aperture 15-Tool steel extrusion die cast design brass-tool steel fitting 16-Tool steel electronic servo or manual stop control release pull pin 17-Tool steel extrusion die cast design internal cavity 18-Tool steel extrusion die cast design internal cavity regulator waste filter and 18B-Tool steel vacuum release portal control.

### BRIEF SUMMARY OF THE INVENTION

Scientific utilization of preform technology the variable hydraulic preform slurry non ionic or electrolyte carbon nanofoam CNFs extrusion high wear-heat resistant parts press FIG. 1 with manufactured or processed carbon nanofoam CNFs available resources enables the manufacture process of high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts, aerospace, automotive, transportation brake calipers, rotors, pads, and bushings and precision casting molds for the manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator up to 2.5 phase extrusions for each A and B specification part.

### DETAILED DESCRIPTION OF THE INVENTION

The variable hydraulic preform slurry non ionic or electrolyte extrusion allotropes of carbon atomic number 6 symbol C herein referred to as preform slurry non ionic or electrolyte carbon and carbon nanofoam CNFs high wear-heat resistant parts press the center of this utility patent application specification manufacture process of specified scientific formula liquid or gas mechanically refined and Nano particle dispersion preform slurry non ionic or electrolyte extrusion carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 45 elements and/or specification 46 alloys manufactured 1. preform slurry non ionic or electrolyte carbon nanofoam CNFs extrusion high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 2. Preform slurry non ionic or electrolyte carbon nanofoam CNFs extrusion high wear-heat resistant parts aerospace, automotive, and transportation brake calipers, rotors, pads, and bushings 3. Preform slurry non ionic or electrolyte carbon nanofoam CNFs extrusion high wear-heat resistant parts precision casting molds for the manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator up to 2.5 phase extrusions for each A and B specification part.

Distillation Reservoir and Recovery Basin Made From Super Alloy and/or Ceramic with Variable

Hydraulic Press Plate for Mechanically Refined and Nano particle or Molten Highly Pure Metal; Super Alloy including Carbon; Carbon Nanofoam CNFs; Alternate Carbon Nano Foam CNFs Inductor; Silica Mineral; Alumina Silica; Acid Solid; Impedance Matching Ceramic Red Brick Insulator; Molybdenum; Ceramic Zirconia; Ceramic Silica; Ceramic Clay; Calcium Carbonate; Alkaline; Minerals; including Ionic Suspension Elements and Ceramic Silica Mineral Insulator for specification 45 elements Highly Pure Metal, specification 46 alloys Distillation reservoir, Ammonia Gas From Nitrogen and Hydrogen Antimony Gas and Halogen Gas with our without suspended elements mechanically refined and Nano particle distillation Carbon Nanofoam CNFs, Alternate Carbon Nanofoam CNfs Inductor, Alumina, Lead, Antimony, Lithium, Nickel, Cadmium, Magnesium, Halide, and Alkalide Distillation Processing and up to Four Pours up to 2.5 phase extrusions or Preform slurry non ionic or electrolyte. Both Processes Molten Pours and Variable Hydraulic Preform slurry non ionic or electrolyte Press in Vacuum Control Room Scientific Distillation Ordinary Atmospheric Pressure less than Ordinary Atmospheric Pressure Catalyst Gases Other specification 45 elements, Argon, Carbon Monoxide, or Carbon Dioxide mechanically refined and Nano particle suspension catalyst Greater or Lesser Than Ordinary Atmospheric Pressure, Super Alloy Super Cooling Refrigeration And Super Alloy Venturi Curvical or Linear Expression Comprising a Scientific Aperture, a Divergence Measured in Angulation, and a Scientific Aperture Diffusion Gaseous Particle Accelerator With Super Cooling Refrigeration Deceleration with or without Nano particle synthesizing Laser Ablation and Multi Waveform Ablation X, Y, And Z Fields and Fractional Vacuum Distillation Gaseous and/or Positive and Negative Ionic Charges Recovery and Super Alloy, Ceramic Zirconium, Ceramic Molybdenum, Ceramic Impedance Matching Red Brick Clay Insulator and/or Ceramic Silica Distillation reservoir with Variable Hydraulic Press Plate Expanded and Contracted Greater or Lesser Than Ordinary Atmospheric Pressure Distillation Recovery Fractional Vacuum Distillation Gaseous and/or Positive Distillation and Variable Hydraulic Press Plate Expanded and Contracted Greater or Lesser Than Ordinary Atmospheric Pressure Distillation Recovery Allotropes of 6—C—Carbon, Solid, and Liquid Chemical Non ionic Groups of Amphoteric Polysaccharide Linear or Branched Alkyl Compounds or Electrolytes and/or Liquid Ions and/or Ionic Melts and/or Fused and/or Acid and Bases Catalyst and/or Catalyst Slurry Reservoir 6—C—Allotropes of Carbon and Liquid and/or Liquid Vapor's, and/or Gaseous Electrolyte Catalyst Acids and Solid Materials Carbon; Carbon Nanofoam CNFs; Alternate Carbon Nano Foam CNFs Inductor; Silica Mineral; Silica Alumina; Acid Solid; Impedance Matching Ceramic Red Brick Insulator; Molybdenum; Ceramic Clay; Calcium Carbonate; Ceramic Zirconia; Silica Mineral; and Minerals for Building Materials trade name Preform Modular fine concrete, mortar, bricks, tiles, and High Wear-Heat Resistant Parts Brushes; Windings; Coils; Drawn; Annealing; Spun; Coils; Windings; Wire; Woven Textile Mesh; Shielding; Brushes; Battery Cells; Electronic Resistors; Capacitors; Brake Pads; Bushings; And up to 2.5 phase extrusions Die Cast Molding.

Distillation and Recovery Basin Variable Hydraulic Press Plate Mold and Carbon Nanofoam CNFs Mold with Pour Aperture located in the center and hydraulic cylinder located on the right Expanded and Contracted for Molten Pouring Highly Pure Metal, Super Alloy including Carbon Nanofoam CNFs, and/or Ceramic 1.0 to 2.0 phase extrusion Plates, Sheets, Foil, and Leaf processor series or parallel circuit conductive or Battery Cell series or parallel circuit conductive Highly Pure Metal, Super Alloy, Carbon Nanofoam CNFs, Ceramic Silica Mineral Insulator, and Ceramic Alumina Silica Carbon Nanofoam CNFs.

Manufacture process of up to 2.5 phase extrusions Die Cast Molding for Precision Casting of Highly Pure Metal, Super Alloy including Carbon Nanofoam CNFs, and/or Ceramic.

The Highly Pure Metal, Super Alloy including Carbon Nanofoam CNFs, and/or Ceramic is a layered greater than 0% to less than 100% Highly Pure Metal or Super Alloy including Carbon Nanofoam CNFs and greater than 0% to less than 100% Other Metal, Super Alloy incuding Carbon Nanofoam CNFs or Ceramic part that is created by pouring molten metal or ceramic into a cast mold over a process of up to 2.5 phase extrusions that create two to six molded casts for each designed master tool steel part that is manually machined and manufactured named Part X external layer Highly Pure Metal or Super Alloy including Carbon Nanofoam CNFs and Part Z the internal layer other Highly Pure Metal, Super Alloy including Carbon Nanofoam CNFs or Ceramic Insulator.

Manufactured process of up to 2.5 phase extrusions Die Cast Molding for Precision Casting of Super Alloy and Ceramic ultimately create a single part identical to the master designed and machine manufactured part with the exception to the chemical element is now a Super Alloy or Super Alloy Ceramic that is layered greater than 0% to less than 100% Highly Pure Metal or Super Alloy including Carbon Nanofoam CNFs and greater than 0% to less than 100% Other Highly Pure Metal, Super Alloy including Carbon Nanofoam CNFs and/or Ceramic. Processing molded halves sequence 1 to 9 of Manufacture process of up to 2.5 phase extrusions Die Cast Molding For Precision Casting of Highly Pure Metal, Super Alloy including Carbon Nanofoam CNFs, and/or Ceramic Part X and Part Z side profile not shown here of casting for Part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 and filled with molten Highly Pure Metal or Super Alloy including Carbon Nanofoam CNFs sequence 9.

The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace.

The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry.

The external tolerances of all of the four cast covers X and Z are identical opposing so that X and Z halves can be joined and prepared for two separate halves molten Highly Pure Metal or Super Alloy including Carbon Nanofoam CNFs fills. After the poured molten Highly Pure Metal or Super Alloy incuding Carbon Nanofoam CNFs cools then both extruded halves are removed and stored. The remainder halves with Highly Pure Metal or Super Alloy including Carbon Nanofoam CNFs are then joined and prepared for a second molten fill of greater than 0% to less than 100% Highly Pure Metal, Super Alloy including Carbon Nanofoam CNFs, and/or Ceramic.

After the fill is cooled the whole part is removed from the cast halves and is inspected, deburred, and/or finished.

The variable hydraulic preform slurry non ionic or electrolyte carbon extrusion high wear-heat resistant parts press FIG. 1 numbers 1 to 18. The 1-Hydraulic control wheel is connected to the 2-Electronic servo and allows the operator to expand and contract 7-Slurry carbon tool steel press plate primarily to expand the 10-Slurry carbon tool steel reservoir by moving the 1-Hydraulic control wheel in a fully counter clockwise fashion. This allows the operator to initiate a separate machine to pump slurry carbon into the 8-Slurry carbon tool steel line in, subsequently to the 9-Gravity feed collector line out and finally to the 10-Slurry carbon tool steel reservoir. Slurry carbon is defined here as specified scientific formula liquid or gas mechanically refined and Nano particle dispersion preform slurry non ionic or electrolyte extrusion carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 45 elements and/or specification 46 alloys manufactured preform slurry non ionic or electrolyte carbon nanofoam CNFs extrusion high wear-heat resistant parts. After the 10-Slurry carbon tool steel reservoir is filled the operator can electronically disengage or manually remove the manual stop control release pull pin. The operator then closes the 9B-Tool steel control to prepare for the extrusion. The operator would proceed by rotating the 1-Hydraulic control wheel in a clockwise fashion contracting the 7-Slurry carbon tool steel press plate and forcing the slurry carbon comprised of slurry formula into the 17-Tool steel extrusion die cast design internal cavity. The specified amount of slurry carbon is compressed to preform slurry non ionic or electrolyte carbon nanofoam CNFs extrusion specification pressure measured in millibars Mb until the specified slurry carbon required to fill the 17-Tool steel extrusion die cast design internal cavity has been reached. The 1-Hydraulic control wheel is then locked until the 17-Tool steel extrusion die cast design internal cavity has been removed.

The 2-Electronic servo sends an electrical signal to the 3-Hydraulic pump of the 7-Slurry carbon tool steel press plate position that is calibrated to the 1-Hydraulic control wheel.

The 3-Hydraulic pump receives an electrical signal from the 2-Electronic servo of the 7-Slurry carbon tool steel press plate position that is calibrated to the 1-Hydraulic control wheel. The 3-Hydraulic pump pumps fluids to the 4-Hydraulic pipe.

The 4-Hydraulic pipe receives fluids from the 3-Hydraulic pump and conveys the fluids to the 5-Hydraulic actuator.

The 5-Hydraulic actuator receives fluids from the 4-Hydraulic pipe and the force from the fluids is transferred through the actuator as vertical up-and-down movement to an affixed 6-Hydraulic arm.

The 6-Hydraulic arm moves vertically up-and-down and forces the 7-Slurry carbon tool steel press plate to expand and contract.

The 7-Slurry carbon tool steel press plate is forced by the 6-Hydraulic arm to expand and contract.

The 8-Slurry carbon tool steel line in receives slurry carbon from an external pump and conveys them to the 9A-Gravity feed tool steel collector. The 8-Slurry carbon tool steel line in can be ionic process tool steel interface positive or negative electrode electronically charged slurry carbon particles for enhanced formulation.

The 9A-Gravity feed tool steel collector receives slurry carbon from the 8-Slurry carbon tool steel line in and conveys them to the 10-Slurry carbon tool steel reservoir.

The 10-Slurry carbon tool steel reservoir receives slurry carbon from the 9A-Gravity feed tool steel collector line out.

After the 10-Slurry carbon tool steel reservoir is filled the 9B-Tool steel control is utilized to close the opening to prepare for the extrusion and may be provisionally locked and stopped at any position.

The 11-Slurry carbon reservoir regulated tool steel waste filter removes waste from the 10-Slurry carbon tool steel reservoir while it is being filled with slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system.

The 12-Slurry carbon reservoir expanded.

The 13-Slurry carbon reservoir contracted.

The 14-Slurry carbon reservoir brass or tool steel aperture and 15-Tool steel extrusion die cast design brass or tool steel fitting connects directly and conveys slurry carbon to the 17-Tool steel extrusion die cast design internal cavity. The 18-Tool steel extrusion die cast design internal cavity regulator waste filter and 18B-Tool steel vacuum release control and portal works in unison with the press plate drawing expanding and contracting slurry carbon removing waste from the 17-Tool steel extrusion die cast design internal cavity while it is being filled with slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system.

The 17-Tool steel extrusion die cast internal cavity is designed as a tool steel extrusion die cast mold for each carbon nanofoam CNFs part comprised of two master extrusion tool steel halves. This is accomplished by first utilizing engineering drafting and computer aided design with the most advanced tool steel part manufacture process and tool steel part machining techniques and/or by utilizing replacement ceramic molds specification number 26 to supplement the development of extrusion die cast master design manufacture process with high purity tool steel die cast extrusion molds. Carbon nanofoam CNFs brake pads, electronic brushes and parts require two master extrusion tool steel mold halves for each specification part. Carbon Nanofoam CNFs parts precision casting molds requires a minimum two and a maximum of six master extrusion tool steel mold halves for each specification part.

Carbon nanofoam CNFs parts precision casting molds are utilized to manufacture highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator up to 2.5 phase extrusions and two to six master carbon nanofoam CNFs mold halves per specification part.

The manufacture process of up to 2.5 phase extrusions and die cast design for highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator requires two to six master extrusion tool steel halves for each two to six reciprocal carbon nanofoam CNFs master precision casting molds parts allowing two A and B highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator to be combined. The 0.5 phase extrusion equals two die cast mold halves both equal to or less than one half 0.5 phase extrusion molten pour.

The utility patent application specification concrete control room and monitoring station manufacturing in a complete vacuum and may supply rich oxygen from capillary feeders at varying points to the specified highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator part molten fill A and B fills up to four pours. The carbon nanofoam CNFs half shell or 0.5 phase extrusion are designed and utilized for state of the art manufacture process when combining highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator in combination of layered foundry fills, parts may be sprayed and dipped non conductive adhesives insulator films, and all waste gases are processed to flu gas detoxification system.

The highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator is a layered greater than 0% to less than 100% alloy component A and greater than 0% to less than 100% alloy component B part that is created in combination of layered foundry fills by utilizing two to six master carbon nanofoam CNFs parts precision casting molds per specification part by pouring molten fill as a layered alloying component highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator four molten metal or other fill pours equal to up to 2.5 phase extrusions.

The highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator is a layered greater than 0% to less than 100% highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator A component part, and greater than 0% to less than 100% highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator B component part created in combination of layered fills of two to six master carbon nanofoam CNFs extrusion die cast mold halves equal to up to 2.5 phase extrusions.

Super carbon alloy is defined as carbon nanofoam CNFs sintered and/or smeltered foundry manufacture process of combined highly pure metal, super alloy, and/or element. The pre and post pour technological standard is accomplished with the utility patent application specification concrete control room and monitoring station manufacturing in a complete vacuum and may supply rich oxygen from capillary feeders at varying points and all waste gases are processed to flu gas detoxification system and includes tolyltriadole, sodium, benzotriadole, methyl, ammoniate, galvanize, anodize, nitrate, nitride, or hydrochloric acid chemical pre and post foundry treatment submersion bath flake and prill anticorrosive purification solution washing and screening table for the manufacture of copper and metals. Hot smelters prepare iron, manganese, lithium, cadmium, lead, nickel, copper, zinc, zirconium, aluminum, titanium, molybdenum, tungsten, or metal for die cast pours and are also utilized for layered foundry fills die cast pours of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator.

All mechanically refined metal ore may be sintered and/or smeltered element additive alloyed carbon nanofoam CNFs, tolyltriadole, sodium, benzotriadole, methyl, ammoniate, galvanize, anodize, nitrate, molybdenum, nitride, or hydrochloric acid and combined alloyed sintered and/or smeltered highly pure metal, super alloy, chromium, or alkaline. All metal ore may be sintered and/or smeltered for homogenization and specific melting point measured in degrees Celsius.

Finely screened grit size mechanically refined copper ore may be pre molten metal chemically treated manufacture process with tolyltriazole, sodium and benzotriazole, methyl, flake, and prill washing and screening table technique and chemical submersion bath for highly pure copper, brass, and bronze alloy anticorrosion purification process sequence.

Replacement ceramic cast 2.5 phase design extrusions die casting for super alloy.

The super alloy is a layered greater than 0% to less than 100% highly pure metal or super alloy and greater than 0% to less than 100% highly pure metal or super alloy part that is created by pouring molten metal into a cast mold over a process of 2.5 phase design extrusions that create four molded casts for each designed master steel part that is manually machined and manufactured named part X the external layer highly pure metal or super alloy and part Z the internal layer highly pure metal or super alloy.

This replacement mold application is for the manufactured process of 2.5 phase design extrusions that creates a single part identical to the master designed and machined manufactured part. The new part chemical element becomes a super alloy that is layered greater than 0% to less than 100% highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator and greater than 0% to less than 100% highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator.

The manufacture process begins by a designed and machined manufactured master part named part X. The master part X is used to create two external cast halves. This is accomplished by casting the master part X into the center of two ceramic molded halves with newly poured ceramic slip and then may be placed in a cool damp room and receive finish application with a wet sponge. After the ceramic cast dries the master part X is removed and the two ceramic molded halves are ignited and cured 3 hours in a kiln at 2000 degrees Fahrenheit or 12 hour interval day at 2000 degrees Fahrenheit. The second master part named part Z is designed and machined manufactured greater than 0% to less than 100% less than tolerances that of the master part X or the external cast halves. The master part Z is used to create two internal cast halves. This is accomplished by casting the master part Z into the center of two ceramic molded halves with newly poured ceramic slip and then may be placed in a cool damp room and receive finish application with a wet sponge. After the ceramic cast dries the master part Z is removed and the two ceramic molded halves are ignited and cured 3 hours in a kiln at 2000 degrees Fahrenheit or 12 hour interval day at 2000 degrees Fahrenheit. After the two ceramic cast halves cool they are used separately to make two reciprocal extrusion halves by pouring ceramic slip into the recesses and joining both halves with new cast covers to dry.

The external tolerances of all of the four cast covers X and Z are identical opposing so that X and Z halves can be joined and prepared for two separate halves molten highly pure metal or super alloy fills. After the poured molten highly pure metal or super alloy cools both extruded halves are removed and stored. The remainder halves with highly pure metal or super alloy fills are then joined and prepared for a second molten fill of greater than 0% to less than 100% highly pure metal or super alloy. After the highly pure metal or super alloy is cooled the whole part is removed from the cast halves and is inspected, deburred, and finished.

The 14-Slurry carbon reservoir brass or tool steel aperture conveys slurry carbon Nanofoam CNFs to the 17-Tool steel extrusion die cast design internal cavity. Carbon nanofoam CNFs slurry electrolyte particle samples are taken and photospectometry analyzed measured in nanometers Nm to enhance slurry formula.

The 16-Tool steel electronic servo or manual stop control release pull pin can be electronically disengaged or manually removed after the 10-Slurry carbon tool steel reservoir is filled to begin the slurry carbon extrusion.

The 18-Tool steel extrusion die cast design internal cavity regulator waste filter removes waste from the 17-Tool steel extrusion die cast design internal cavity while it is being filled with slurry carbon. The 18-Tool steel extrusion die cast design internal cavity regulator waste filter and 18B-Tool steel vacuum release control with processing may utilize an external vacuum pump for required specifications specified scientific formula liquid or gas mechanically refined and Nano particle dispersion preform slurry non ionic or electrolyte extrusion carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 45 elements and/or specification 46 alloys.

The manufacture process of preform slurry non ionic or electrolyte carbon nanofoam CNFs extrusion high wear-heat resistant part is to cool it and/or dry it at room temperature in degrees Celsius or cure the part in a furnace typically for 5 to 20 minutes from 1076 degrees Fahrenheit to 3230 degrees Fahrenheit.

Preform slurry non ionic or electrolyte making of four sections 1. Preform slurry non ionic or electrolyte carbon nanofoam CNFs extrusion high wear-heat resistant part 2. Preform slurry non ionic or electrolyte carbon nanofoam CNFs extrusion high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 3. Preform slurry non ionic or electrolyte carbon nanofoam CNFs extrusion high wear-heat resistant parts aerospace, automotive, and transportation brake calipers, rotors, pads, and bushings 4. Preform slurry non ionic or electrolyte carbon nanofoam CNFs extrusion high wear-heat resistant parts precision casting molds for the manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator up to 2.5 phase extrusions two to six master preform slurry non ionic or electrolyte carbon nanofoam CNFs extrusion high wear-heat resistant parts precision casting molds. All of up to 2.5 phase extrusions and half shell castings are processed utility patent application specification concrete control room and monitoring station manufacturing in a complete vacuum and may supply rich oxygen from capillary feeders at varying points to molten elements in crucibles, and extrusion molds parts may be sprayed and dipped non conductive adhesives insulator films and all waste gases are processed to flu gas detoxification system.

Preform slurry non ionic or electrolyte carbon nanofoam CNFs made by the variable hydraulic preform slurry non ionic or electrolyte carbon nanofoam CNFs extrusion high wear-heat resistant parts press FIG. 1 numbers 1 to 18. Number 5. The variable hydraulic preform slurry non ionic or electrolyte carbon nanofoam CNFs extrusion high wear-heat resistant parts press with FIG. 1 numbers 1 to 18 specific components that conform to specified requirements to unique American Society for Testing and Materials International Standards Worldwide Identifiers. The variable hydraulic preform slurry non ionic or electrolyte carbon nanofoam CNFs extrusion high wear-heat resistant parts press, the center of this utility patent application specification slurry electrolyte formula in three scientific forms of Solids 6, Liquids 7 and Gases 8 noble gas argon or element in a gaseous state specified scientific formula liquid or gas mechanically refined and Nano particle dispersion preform slurry non ionic or electrolyte extrusion carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 45 elements and/or specification 46 alloys manufactured preform slurry non ionic or electrolyte carbon nanofoam CNFs extrusion high wear-heat resistant parts.

Utility patent application specification concrete control room and monitoring station manufacturing in a complete vacuum and may supply rich oxygen from capillary feeders at varying points to utility patent application specification for with die cast mold extrusion or printing hot smelters casting manufacturing of specified highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator including two to six master extrusion halves up to 2.5 phase extrusions per specification part molten foundry fill up to four pours, and the manufacture process or assembly for each specification component or part thereof and all waste gases are processed to flu gas detoxification system.

Utility patent application specification concrete control room and monitoring station manufacturing in a complete vacuum and may supply rich oxygen from capillary feeders at varying points to utility patent application specification manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator hot pouring casting printing with molten foundry fill of die cast mold precision casting of bars, rods, plates, sheets, foil, leaf, copper wire, drawing, annealing, and spun coils and windings for electronic component, or other metal drawing and annealing process for Wire, spun Cable, and Rebar textile mesh, with or without woven textile synthetic or natural fibers unit of measurement in gage trade name Rebar Cable or Manufacture Process Connector System, cable connectors, powders, nitrate hardened or non hardened trade name Nitride Steel Grit unit of measurement in mesh or grit size and manufacturing of carbon nanofoam CNFs super alloy trade name Super Carbon Alloy.

Utility patent application specification concrete control room and monitoring station manufacturing in a complete vacuum and may supply rich oxygen from capillary feeders at varying points to utility patent application specification up to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system.

Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake Of and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath nitrate, hydrochloric acid, ammonia from nitrogen, and hydrogen anticorrosive purification treatment and all waste gases are processed to flu gas detoxification system.

Utility patent application specification concrete control room and monitoring station manufacturing in a complete vacuum and may supply rich oxygen from capillary feeders at varying points to mechanically refined metal ore sintered and smeltered nonmetallic additive carbon nanofoam CNFs alloyed trade name Super Carbon Alloy, steel trade name Super Carbon Steel, tungsten trade name Super Carbon Tungsten, or additive sintered and smeltered molybdenum for homogenization steel trade name Molybdenum Steel, or tungsten trade name Molybdenum Tungsten and all waste gases are processed to flu gas detoxification system.

Utility patent application specification manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator up to 2.5 phase extrusions or half shell casted composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor six sides rectangle, or square, or three sides continuous rod or cylinder highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor, or three sides zircon cutting tools, or two sides continuous for drill bits half shell casted tools measured in gage.

Utility patent application specification manufacturing of highly pure metal or super alloy tool steel tungsten forge die cast tool, crimping tool for trade name Rebar Cable or Manufacture Process Connector System, specific tool steel parts that conform to specified requirements to unique American Society for Testing and Materials International Standards Worldwide Identifiers the variable hydraulic preform slurry non ionic or electrolyte carbon nanofoam CNFs extrusion high wear-heat resistant parts press FIG. 1 numbers 1 to 18 and tool steel tungsten die cast extrusion molds for with manufacturing highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor.

Utility patent application specification manufacture process of replacement ceramic precision casting molds specification number 26 for with manufacturing highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor.

Utility patent application specification manufacture process of preform slurry non ionic or electrolyte carbon nanofoam CNFs with or without ionic suspension element specification 45 elements or specification 46 alloys extrusion or casted highly pure metal, super alloy, carbon nanofoam CNFs with or without ionic suspension element specification 45 elements or specification 46 alloys, and alkaline, halide, alkalide, nonconductive zirconia, or impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series or parallel circuit two positive and negative terminals measured in Volts, or of preform slurry non ionic or electrolyte alternate carbon nanofoam CNFs inductor extrusion, or casted highly pure metal, super alloy, alternate carbon nanofoam CNFs inductor, nonconductive zirconia, and impedance matching load or signal ceramic red brick clay insulator electronic part equivalent to one resistor, switch, relay, or electronic part inductor, antinode coupler, and ground series or parallel circuit two negative terminals measured in Ohms of inductor, antinode coupler, and ground or two positive and negative terminals measured in Volts. All electronic parts two sides casted conductive plate, sheet, foil, or leaf highly pure metal, super alloy, and alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam CNFs inductor, plate, sheet, foil, or leaf casted insulated, and one side layered or non layered conductive highly pure metal, super alloy, and/or alkaline, halide, or alkalide, plate, sheet, foil, or leaf casted conductive, or four sides nonconductive zirconia, impedance matching load or signal ceramic red brick clay insulator, carbon nanofoam CNFs, or alternate carbon nanofoam CNFs inductor casted plate, sheet, foil, or leaf insulated, and two conductive highly pure metal, super alloy, and/or alkaline, halide, or alkalide, plate, sheet, foil, or leaf casted series or parallel circuit and two positive and negative terminals measured in Volts or two negative terminals measured in Ohms to antinode coupler, or continuous rod or cylinder three sides, one continuous side nonconductive zirconia, impedance matching load or signal ceramic red brick clay insulator, carbon nanofoam CNFs, or alternate carbon nanofoam CNFs inductor, plate, sheet, foil, or leaf casted insulated, and two sides conductive highly pure metal, super alloy, and/or alkaline, halide, or alkalide, plate, sheet, foil, or leaf casted series or parallel circuit and two positive and negative terminals measured in Volts or two negative terminals measured in Ohms to antinode coupler preform slurry non ionic or electrolyte casted ionic suspension element carbon nanofoam CNFs battery cell outstanding one or two sides plate, sheet, foil, or leaf casted conductive highly pure metal, super alloy, and alkalide series or parallel circuit and two positive and negative terminals measured in Volts or two negative terminals measured in Ohms to antinode coupler or electronic parts requires one, or two, or more brushes in even intervals and two or more inductors and antinode couplers with one or two sides conductive plate, sheet, foil, or leaf casted highly pure metal, super alloy, and alkalide series or parallel circuit and two positive and negative terminals measured in Volts or two negative terminals measured in Ohms to antinode coupler.

Variable hydraulic preform slurry non ionic or electrolyte silicate carbon nanofoam CNFs extrusion high wear-heat compression resistant light weight insulator or electronic part battery cell ceramic or alkali metal silica colorless and transparent Tetramethyl orthosilica Si(OCH₃)₄ Carbon Nanofoam CNFs trade name silicate Carbon Nanofoam CNFs slurry carbon electrolyte clustered nanoparticles are achieved by heated or chilled interface 8-Slurry carbon tool steel line in liquid dispersion heated Tetramethyl orthosilica Si(OCH₃)_{4,} methanol MEOH, and Carbon Nanofoam CNFs or liquid dispersion chilled polyvinyl alchohol PVA reinforcement, and Carbon Nanofoams CNFs networks in suspension drying over usually fifteen minutes result network light weight silicate Carbon Nanofoams CNFs controllable, high purity, connectivity, strength, conductivity, and shape.

Super Battery construction begins with crucible casted or up to 2.5 phase extrusions highly pure metal or Super Alloy battery cells layered, spaced and casted conductive in series or parallel circuit even or odd interval number combinations varying complex battery cells highly pure acid solid chemical and/or highly pure chemical alkali solid complex crucible casted conductive or up to 2.5 phase extrusions highly pure metal or Super Alloy layered and interval spaced conductive in series or parallel circuit. Super Battery with or without lightweight super impregnated suspension element, Halogen, Antimony, or Chemical Element gases ammonia, from nitrogen, and hydrogen, hydrochloric acid with or without ionic suspension element carbon nanofoam CNFs and ionic suspension element specification 45 highly pure metals or ionic suspension element specification 46 Super Alloys and/or Alumina, crucible casted conductive or up to 2.5 phase extrusions highly pure metal or Super Alloy layered, and interval spaced series or parallel circuit and/or complex crucible casted conductive or up to 2.5 phase extrusions Variable hydraulic preform slurry non ionic or electrolyte silicate carbon nanofoam CNFs extrusion high wear-heat compression resistant light weight battery cells. Highly pure alkali silica, alumina or elements lithium, cadmium, nickel, lead, copper, specification 45 elements or specification 46 alloys. One by one Super Battery—Each battery cell crucible casted non conductive or submersion bath sealed Thermoplastic synthetic composite polymer insulation control room vacuum protocol manufacture process. Motor frame may be dipped Thermoplastic sealed or synthetic polymer fiber textile mesh, silicate fiber heat resistant textile mesh, Variable hydraulic preform slurry non ionic silicate carbon nanofoam CNFs extrusion high wear-heat compression resistant light weight insulator, and/or high tensile strength Super Carbon Alloy textile shielded mesh. One by one Super Battery—Each battery cell crucible casted or submersion bath sealed Thermoplastic synthetic composite polymer insulator control room vacuum protocol manufacture process. All four conductive or nonconductive heat-wear high tensile strength and compression resistant insulators are designed and built in Monocomb and corrugated—compartmented composite combinations Thermoplastic sealed, layered or woven shielded.

Super Motor construction begins with crucible casted or up to 2.5 phase extrusions highly pure metal or Super Alloy composite coils, composite windings, and copper wire drawing, annealing, and spun coils or other highly pure metal including highly pure metal or Super Alloy drawing and annealing process for wire. Super Motors composite coils, composite windings usually copper or Super Alloy includes continuous or numeric interval spools shapes of rod, cylinder, sphere, rectangle, or square crucible casted or up to 2.5 phase extrusions. Super Motor electronic components brushes Carbon Nanofoam CNFs with or without ionic suspension elements each brush alternate carbon nanofoam inductors, and antinode coupler continuous or numeric ramps positive and negative terminal measured in volts and monitors positive and negative terminal measured in volts and negative and negative terminals measured in Ohms of inductor, antinode coupler, and ground series or parallel circuit. Spun numeric copper or Super Carbon Copper Alloy wire may be dipped thermoplastic sealed or synthetic polymer fibers textile shielded mesh, woven silicate heat resistant fibers textile shielded mesh, and high tensile strength carbon nanofoam CNFs Super Alloy shielded cable textile mesh and motor frame may be dipped thermoplastic sealed or synthetic polymer fiber textile shielded mesh, silicate fiber high heat-resistant insulator textile shielded mesh, and/or high tensile strength Super Carbon Alloy textile shielded mesh. One by one all composite or wire Super—Motor coils and windings are crucible casted or submersion bath sealed Thermoplastic synthetic composite polymer insulator control room vacuum protocol manufacture process. Three heat-wear high tensile strength and Variable hydraulic preform slurry non ionic or electrolyte silicate carbon nanofoam CNFs extrusion high wear-heat compression resistant light weight insulators are designed and built in Monocomb and corrugated—compartmented composite combinations Thermoplastic sealed, layered or woven shielded. Crucible casted or up to 2.5 phase extrusions motor casings, rods, bearings, housings, and assemblies are manufactured and assembled.

Specification Periodic Table Element Groups Alkali Metals, Alkalide Earth Metals, Transition Metals, Other Metals, Metalloids, Non-Metals, Halogens, Noble Gases, and Rare Earth Element here in atomic number, element symbols, and names 3—Li—Lithium, 4—Be—Beryllium, 5—B—Boron, 12—Mg—Magnesium, 13—Al—Aluminum, 21—Sc—Scandium, 22—Ti—Titanium, 23—V—Vanadium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 32—Ge—Germanium, 33—As—Arsenic, 37—Rb—Rubidium, 38—Sr—Strontium, 39—Y—Yttrium, 40—Zr—Zirconium, 41—Nb—Niobium, 42—Mo—Molybdenum, 43—Tc—Technetium, 44—Ru—Ruthenium, 45—Rh—Rhodium, 46—Pd—Palladium, 47—Ag—Silver, 48—Cd—Cadmium, 49—In—Indium, 50—Sn—Tin, 51—Sb—Antimony, 52—Te—Tellurium, 55—Cs—Cesium, 56—Ba—Barium, 57—La—Lanthanum, 58—Ce—Cerium, 59—Pr—Praseodymium, 60—Nd—Neodymium, 61—Pm—Promethium, 62—Sm—Samarium, 63—Eu—Europium, 64—Gd—Gadolinium, 65—Tb—Terbium, 66—Dy—Dysprosium, 67—Ho—Holmium, 68—Er—Erbium, 69—Tm—Thulium, 70—Yb—Ytterbium, 71—Lu—Lutetium, 72—Hf—Hafnium, 73—Ta—Tantalum, 74—W—Tungsten, 75—Re—Rhenium, 76—Os—Osmium, 77—Ir—Iridium, 78—Pt—Platinum, 79—Au—Gold, 80—Hg—Mercury, 81—TI—Thallium, 82—Pb—Lead, 83—Bi—Bismuth, 84—Po—Polonium, 85—At—Astatine, 87—Fr—Francium, 88—Ra—Radium, 89—Ac—Actinium, 90—Th—Thorium, 91—Pa—Protactinium, 92—U—Uranium, 93—Np—Neptunium, 94—Pu—Plutonium, 95—Am—Americium, 96—Cm—Curium, 97—Bk—Berkelium, 98—Cf—Californium, 99—Es—Einsteinium, 100—Fm—Fermium, 101—Md—Mendelevium, 102—No—Nobelium, 103—Lr—Lawrencium, 104—Rf—Rutherfordium, 105—Db—Dubnium, 106—Sg—Seaborgium, 107—Bh—Bohrium, 108—Hs—Hassium, 109—Mt—Meitnerium, 110—Ds—Darmstadtium, 111—Rg—Roentgenium, 112—Cn—Copernicium, 113—Uut—Ununtrium, 114—Uuq—Ununquadium, 115—Uup—Ununpentium, 116—Uuh—Ununhexium, 117—Uus—Ununseptium, and/or 118—Uuo—Ununoctiurn.

Specification Alloys metallurgy substances that are a mixture of two or more metals, or of a metal with a nonmetallic material not limited to Aluminum Alloys AA-8000 used for building wire; Al—Li aluminum, lithium, sometimes mercury; Alnico aluminum, nickel, copper; Duralumin copper, aluminum; Magnalium aluminum, 5% magnesium; Magnox magnesium oxide, aluminum; Nambe aluminum plus seven other unspecified metals; Silumin aluminum, silicon; and Zamak zinc, aluminum, magnesium, copper; Aluminum forms other complex alloys with magnesium, manganese, and platinum. Bismuth Alloys Wood's metal bismuth, lead, tin, cadmium; Rose metal bismuth, lead, tin; Field's metal; and Cerrobend. Cobalt Alloys Megallium; and Stellite cobalt, chromium, tungsten or molybdenum, carbon Talonite cobalt, chromium. Ultimet cobalt, chromium, nickel, molybdenum, iron, tungsten; and Vitallium. Copper Alloys Arsenical copper; Beryllium copper, beryllium; and Billon copper, silver. Brass copper, zinc; Calamine brass copper, zinc; Chinese silver copper, zinc; Dutch metal copper, zinc; Gilding metal copper, zinc; Muntz metal copper, zinc; Pinchbeck copper, zinc; Prince's metal copper, zinc; and Tombac copper, zinc. Bronze copper, tin, aluminum or other element; Aluminum bronze copper, aluminum; Arsenical bronze copper, arsenic; Bell metal copper, tin; Florentine bronze copper, aluminum or tin; Glucydur beryllium, copper, iron; Guanin likely a manganese bronze of copper, manganese, with iron sulfides and other sulfides; Gunmetal copper, tin, zinc; Phosphor bronze copper, tin and phosphorus; Ormolu Gilt Bronze copper, zinc; and Speculum metal copper, tin. Constantan copper, nickel; Copper-tungsten copper, tungsten; Corinthian bronze copper, gold, silver; Cunife copper, nickel, iron; Cupronickel copper, nickel; Cymbal alloys Bell metal copper, tin; Devarda's alloy copper, aluminum, zinc; Electrum copper, gold, silver; Hepatizon copper, gold, silver; Heusler alloy copper, manganese, tin; Manganin copper, manganese, nickel; Nickel silver copper, nickel; Nordic gold copper, aluminum, zinc, tin; Shakudo copper, gold; and Tumbaga copper, gold. Gallium Alloys Galinstan gallium, indium, tin. Gold Alloys Electrum gold, silver, copper; Tumbaga gold, copper; Rose gold, copper; and White gold, nickel, palladium, or platinum. Indium Alloys Field's metal indium, bismuth, tin. Iron or Ferrous Alloys Steel carbon Stainless steel chromium, nickel; AL-6XN; Alloy 20; Celestrium; Marine grade stainless; Martensitic stainless steel; and Surgical stainless steel chromium, molybdenum, nickel. Silicon steel silicon; Tool steel tungsten or manganese; Bulat steel; Chromoly chromium, molybdenum; Crucible steel; Damascus steel; HSLA steel; High speed steel; Maraging steel; Reynolds 531; and Wootz steel. Iron Anthracite iron carbon; Cast iron carbon; Pig iron carbon; and Wrought iron carbon. Fernico nickel, cobalt; Elinvar nickel, chromium; Invar nickel; Kovar cobalt; and Spiegeleisen manganese, carbon, silicon. Ferroalloys Ferroboron; Ferrochrome chromium; Ferromagnesium; Ferromanganese; Ferromolybdenum; Ferronickel; Ferrophosphorus; Ferrotitanium; Ferrovanadium; and Ferrosilicon. Lead Alloys Antimonial lead, antimony; Molybdochalkos lead, copper; Solder lead, tin; Terne lead, tin; and Type metal lead, tin, antimony. Magnesium Alloys Magnox magnesium, aluminum T-Mg—Al—Zn Bergman phase; and Elektron. Mercury Alloys Amalgam mercury and other metal except platinum. Nickel Alloys Alumel nickel, manganese, aluminum, silicon; Chromel nickel, chromium; Cupronickel nickel, bronze, copper; German silver nickel, copper, zinc; Hastelloy nickel, molybdenum, chromium, sometimes tungsten; Inconel nickel, chromium, iron; Monel metal copper, nickel, iron, manganese; Mu-metal nickel, iron; Ni-C nickel, carbon; Nichrome chromium, iron, nickel; Nicrosil nickel, chromium, silicon, magnesium; Nisil nickel, silicon; and Nitinol nickel, titanium, shape memory alloy. Potassium Alloys KLi potassium, lithium; and NaK sodium, potassium. Rare Earth Alloys Mischmetal various rare earths. Silver Alloys Argentium sterling silver, copper, germanium; Billon copper or copper bronze, sometimes with silver; Britannia silver, copper; Electrum silver, gold; Goloid silver, copper, gold; Platinum sterling silver, platinum; Shibuichi silver, copper; and Sterling silver, copper. Tin Alloys Britannium tin, copper, antimony; Pewter tin, lead, copper; and Solder tin, lead, antimony. Titanium Alloys Beta C titanium, vanadium, chromium, other metals; and 6al-4v titanium, aluminum, vanadium. Uranium Alloys Staballoy depleted uranium with titanium or molybdenum; and Uranium may also be alloyed with plutonium. Zinc Alloys Brass zinc, copper; and Zamak zinc, aluminum, magnesium, copper. Zirconium Alloys Zircaloy zirconium and tin, sometimes with niobium, chromium, iron, nickel.

1. Preform slurry non ionic or electrolyte carbon nanofoam CNFs made by the variable hydraulic preform slurry non ionic or electrolyte carbon nanofoam CNFs extrusion high wear-heat resistant parts press. 1. The variable hydraulic preform slurry non ionic or electrolyte carbon nanofoam CNFs extrusion high wear-heat resistant parts Press with FIG. 1 numbers 1 to 18 specific components that conform to specified requirements to unique American Society for Testing and Materials International Standards Worldwide Identifiers. The variable hydraulic preform slurry non ionic or electrolyte carbon nanofoam CNFs extrusion high wear-heat resistant parts press, the center of this utility patent application specification slurry electrolyte formula in three scientific forms of Solids, Liquids and Gases noble gas argon or element in a gaseous state specified scientific formula liquid or gas mechanically refined and Nano particle dispersion preform slurry non ionic or electrolyte extrusion carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 45 elements and/or specification 46 alloys manufactured preform slurry non ionic or electrolyte carbon nanofoam CNFs extrusion high wear-heat resistant parts. Slurry carbon tool steel line in can be ionic process tool steel interface positive or negative electrode electronically charged CNFs and electrolyte particle for enhanced formulation. Specified amount of slurry carbon is compressed to preform slurry non ionic or electrolyte carbon nanofoam CNFs extrusion specification pressure measured in millibars Mb. Slurry carbon reservoir regulated tool steel waste filter removes waste from the Slurry carbon tool steel reservoir while it is being filled with slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system. Tool steel extrusion die cast design internal cavity regulator waste filter and tool steel vacuum release control and portal works in unison with the press plate drawing expanding and contracting slurry carbon removing waste from the tool steel extrusion die cast design internal cavity while it is being filled with slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system. Distillation Reservoir and Recovery Basin Made From Super Alloy and/or Ceramic with Variable Hydraulic Press Plate for Mechanically Refined or Molten Highly Pure Metal; Super Alloy including Carbon Nanofoam CNFs; Carbon; Carbon Nanofoam CNFs; Alternate Carbon Nano Foam CNFs Inductor; Silica Mineral; Alumina Silica; Acid Solid; Impedance Matching Ceramic Red Brick Insulator; Molybdenum; Ceramic Zirconia; Ceramic Silica; Ceramic Clay; Calcium Carbonate; Alkaline; Minerals; including Ionic Suspension Elements and Ceramic Silica Mineral Insulator for specification 45 elements Highly Pure Metal, specification 46 alloys including Carbon Nanofoam CNFs, Copper, Acid Solid, Alkaline, Alumina Silica, Lithium, Cadmium, Nickel, Antimony mechanically refined Solid and Gas with Suspended Carbon Nanofoam CNFs, Lead, Magnesium, Ammonia Gas From Nitrogen and Hydrogen and Halogen Gas with our without suspended elements mechanically refined alumina particles, Halide, and Alkalide Distillation Processing and up to Four Pours up to 2.5 phase extrusions or Preform slurry non ionic or electrolyte. Both Processes Molten Pours and Variable Hydraulic Preform slurry non ionic or electrolyte Press in Vacuum Control Room Under Scientific Principle of Distillation Ordinary Atmospheric Pressure less than Ordinary Atmospheric Pressure Catalyst Gases Other specification 45 elements, Argon, Carbon Monoxide, or Carbon Dioxide mechanically refined particle suspension catalyst Greater or Lesser Than Ordinary Atmospheric Pressure, Super Alloy Super Cooling Refrigeration And Super Alloy Venturi Curvical or Linear Expression Comprising a Scientific Aperture, a Divergence Measured in Angulation, and a Scientific Aperture Diffusion Gaseous Particle Accelerator With Super Cooling Refrigeration Deceleration with or without Nano particle synthesizing Laser Ablation and Multi Waveform Ablation X, Y, And Z Fields and Fractional Vacuum Distillation Gaseous and/or Positive and Negative Ionic Charges Recovery and Super Alloy, Ceramic Zirconium, Ceramic Molybdenum, Ceramic Impedance Matching Red Brick Clay Insulator and/or Ceramic Silica Distillation reservoir with Variable Hydraulic Press Plate Expanded and Contracted Greater or Lesser Than Ordinary Atmospheric Pressure Distillation Recovery Fractional Vacuum Distillation Gaseous and/or Positive Distillation and Variable Hydraulic Press Plate Expanded and Contracted Greater or Lesser Than Ordinary Atmospheric Pressure Distillation Recovery Allotropes of 6—C—Carbon, Solid, and Liquid Chemical Non ionic Groups of Amphoteric Polysaccharide Linear or Branched Alkyl Compounds or Electrolytes and/or Liquid Ions and/or Ionic Melts and/or Fused and/or Acid and Bases Catalyst and/or Catalyst Slurry Reservoir 6—C—Allotropes of Carbon and Liquid and/or Liquid Vapor's, and/or Gaseous Electrolyte Catalyst Acids and Solid Materials Carbon; Carbon Nanofoam CNFs; Alternate Carbon Nano Foam CNFs Inductor; Silica Mineral; Silica Alumina; Acid Solid; Impedance Matching Ceramic Red Brick Insulator; Molybdenum; Ceramic Clay; Calcium Carbonate; Ceramic Zirconia; Silica Mineral; and Minerals for Building Materials trade name Preform Modular fine concrete, mortar, bricks, tiles, and High Wear-Heat Resistant Parts Brushes; Windings; Coils; Drawn; Annealing; Spun; Coils; Windings; Wire; Woven Textile Mesh; Shielding; Battery Cells; Electronic Resistors; Capacitors; Brake Pads; Bushings; And up to 2.5 phase extrusions Die Cast Molding. Distillation and Recovery Basin Variable Hydraulic Press Plate Mold and Carbon Nanofoam CNFs Mold with Pour Aperture located in the center and hydraulic cylinder located on the right Expanded and Contracted for Molten Pouring Highly Pure Metal, Super Alloy including Carbon Nanofoam CNFs, and/or Ceramic 1.0 to 2.0 phase extrusion Plates, Sheets, Foil, and Leaf processor series or parallel circuit conductive or Battery Cell series or parallel circuit conductive Highly Pure Metal, Super Alloy, Carbon Nanofoam CNFs, Ceramic Silica Mineral Insulator, and Ceramic Alumina Silica Carbon Nanofoam CNFs Battery Cell.
Manufacture process of up to 2.5 phase extrusions Die Cast Molding for Precision Casting of Highly Pure Metal, Super Alloy including Carbon Nanofoam CNFs, and/or Ceramic.
The Highly Pure Metal, Super Alloy including Carbon Nanofoam CNFs, and/or Ceramic is a layered greater than 0% to less than 100% Highly Pure Metal or Super Alloy including Carbon Nanofoam CNFs and greater than 0% to less than 100% Other Metal, Super Alloy incuding Carbon Nanofoam CNFs or Ceramic part that is created by pouring molten metal or ceramic into a cast mold over a process of up to 2.5 phase extrusions that create two to six molded casts for each designed master tool steel part that is manually machined and manufactured named Part X external layer Highly Pure Metal or Super Alloy including Carbon Nanofoam CNFs and Part Z the internal layer other Highly Pure Metal, Super Alloy including Carbon Nanofoam CNFs or Ceramic Insulator.
Manufactured process of up to 2.5 phase extrusions Die Cast Molding for Precision Casting of Super Alloy and Ceramic ultimately create a single part identical to the master designed and machine manufactured part with the exception to the chemical element is now a Super Alloy or Super Alloy Ceramic that is layered greater than 0% to less than 100% Highly Pure Metal or Super Alloy including Carbon Nanofoam CNFs and greater than 0% to less than 100% Other. Highly Pure Metal, Super Alloy including Carbon Nanofoam CNFs and/or Ceramic. Processing molded halves sequence 1 to 9 of Manufacture process of up to 2.5 phase extrusions Die Cast Molding For Precision Casting of Highly Pure Metal, Super Alloy including Carbon Nanofoam CNFs, and/or Ceramic Part X and Part Z side profile not shown here of casting for Part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 and filled with molten Highly Pure Metal or Super Alloy including Carbon Nanofoam CNFs sequence 9.
The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace.
The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry.
The external tolerances of all of the four cast covers X and Z are identical opposing so that X and Z halves can be joined and prepared for two separate halves molten Highly Pure Metal or Super Alloy including Carbon Nanofoam CNFs fills. After the poured molten Highly Pure Metal or Super Alloy incuding Carbon Nanofoam CNFs cools then both extruded halves are removed and stored. The remainder halves with Highly Pure Metal or Super Alloy including Carbon Nanofoam CNFs are then joined and prepared for a second molten fill of greater than 0% to less than 100% Highly Pure Metal, Super Alloy including Carbon Nanofoam CNFs, and/or Ceramic.
After the fill is cooled the whole part is removed from the cast halves and is inspected, deburred, and/or finished.

2. Utility patent application specification concrete control room and monitoring station manufacturing in a complete vacuum and may supply rich oxygen from capillary feeders at varying points to utility patent application specification for with die cast mold extrusion or printing hot smelters, crucibles casting, and 2.5 phase die mold extrusion manufacturing of specified highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator two to six master extrusion halves up to 2.5 phase extrusions per specification part molten foundry fill up to four pours, and the manufacture process or assembly for each specification component or part thereof parts may be sprayed and dipped non conductive adhesives insulator films and all waste gases are processed to flu gas detoxification system. 2. Utility patent application specification concrete control room and monitoring station manufacturing in a complete vacuum and may supply rich oxygen from capillary feeders at varying points to utility patent application specification manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator hot pouring casting printing with molten foundry fill of die cast mold precision casting of bars, rods, plates, sheets, foil, leaf, copper wire, drawing, annealing, and spun coils and windings for electronic component, or other metal drawing and annealing process for Wire, spun Cable, and Rebar textile mesh with or without woven textile synthetic or natural fibers unit of measurement in gage trade name Rebar Cable or Manufacture Process Connector System, cable connectors, powders, nitrate hardened or non hardened trade name Nitride Steel Grit unit of measurement in mesh or grit size and manufacturing of carbon nanofoam CNFs super alloy trade name Super Carbon Alloy. 3. Utility patent application specification concrete control room and monitoring station manufacturing in a complete vacuum and may supply rich oxygen from capillary feeders at varying points to utility patent application specification up to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system. 4. Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath nitrate, hydrochloric acid, ammonia from nitrogen, and hydrogen anticorrosive purification treatment and all waste gases are processed to flu gas detoxification system. 5. Utility patent application specification concrete control room and monitoring station manufacturing in a complete vacuum and may supply rich oxygen from capillary feeders at varying points to mechanically refined metal ore sintered and smeltered nonmetallic additive carbon nanofoam CNFs alloyed trade name Super Carbon Alloy, steel trade name Super Carbon Steel, tungsten trade name Super Carbon Tungsten, or additive sintered and smeltered molybdenum for homogenization steel trade name Molybdenum Steel, or tungsten trade name Molybdenum Tungsten and all waste gases are processed to flu gas detoxification system. 6. Utility patent application specification manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator up to 2.5 phase extrusions or half shell casted composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor six sides rectangle, or square, or three sides continuous rod or cylinder highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor, or three sides zircon cutting tools, or two sides continuous for drill bits half shell casted tools measured in gage. 7. Utility patent application specification manufacturing of highly pure metal or super alloy tool steel tungsten forge die cast tool, crimping tool for trade name Rebar Cable or Manufacture Process Connector System, specific tool steel parts that conform to specified requirements to unique American Society for Testing and Materials International Standards Worldwide Identifiers The variable hydraulic preform slurry non ionic or electrolyte carbon nanofoam CNFs extrusion high wear-heat resistant parts Press FIG. 1 numbers 1 to 18 and tool steel tungsten die cast extrusion molds for with manufacturing highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor. 8. Utility patent application specification manufacture process of replacement ceramic precision casting molds specification number 26 for with manufacturing highly pure metal, super alloy, acid solid, alkaline, halide, alkalide, nonconductive zirconia, impedance matching load or signal ceramic red brick clay insulator, carbon nanofoam CNFs, or alternate carbon nanofoam CNFs inductor. 9. Utility patent application specification manufacture process of preform slurry non ionic or electrolyte carbon nanofoam CNFs with or without ionic suspension element specification 45 elements or specification 46 alloys extrusion or casted highly pure metal, super alloy, carbon nanofoam CNFs with or without ionic suspension element specification 45 elements or specification 46 alloys, and alkaline, halide, alkalide, nonconductive zirconia, or impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series or parallel circuit two positive and negative terminals measured in Volts, or of preform slurry non ionic or electrolyte alternate carbon nanofoam CNFs inductor extrusion, or casted highly pure metal, super alloy, alternate carbon nanofoam CNFs inductor, nonconductive zirconia, and impedance matching load or signal ceramic red brick clay insulator electronic part equivalent to one resistor, switch, relay, or electronic part inductor, antinode coupler, and ground series or parallel circuit two negative terminals measured in Ohms of inductor, antinode coupler, and ground or two positive and negative terminals measured in Volts. All electronic parts two sides casted conductive plate, sheet, foil, or leaf highly pure metal, super alloy, and alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam CNFs inductor, plate, sheet, foil, or leaf casted insulated, and one side layered or non layered conductive highly pure metal, super alloy, and/or alkaline, halide, or alkalide, plate, sheet, foil, or leaf casted conductive, or four sides nonconductive zirconia, impedance matching load or signal ceramic red brick clay insulator, carbon nanofoam CNFs, or alternate carbon nanofoam CNFs inductor casted plate, sheet, foil, or leaf insulated, and two conductive highly pure metal, super alloy, and/or alkaline, halide, or alkalide, plate, sheet, foil, or leaf casted series or parallel circuit and two positive and negative terminals measured in Volts or two negative terminals measured in Ohms to antinode coupler, or continuous rod or cylinder three sides, one continuous side nonconductive zirconia, impedance matching load or signal ceramic red brick clay insulator, carbon nanofoam CNFs, or alternate carbon nanofoam CNFs inductor, plate, sheet, foil, or leaf casted insulated, and two sides conductive highly pure metal, super alloy, and/or alkaline, halide, or alkalide, plate, sheet, foil, or leaf casted series or parallel circuit and two positive and negative terminals measured in Volts or two negative terminals measured in Ohms to antinode coupler preform slurry non ionic or electrolyte casted ionic suspension element carbon nanofoam CNFs battery cell outstanding one or two sides plate, sheet, foil, or leaf casted conductive highly pure metal, super alloy, and alkalide series or parallel circuit and two positive and negative terminals measured in Volts or two negative terminals measured in Ohms to antinode coupler or electronic parts requires one, or two, or more brushes in even intervals and two or more inductors and antinode couplers with one or two sides conductive plate, sheet, foil, or leaf casted highly pure metal, super alloy, and alkalide series or parallel circuit and two positive and negative terminals measured in Volts or two negative terminals measured in Ohms to antinode coupler. 10. An electronic part light weight ceramic or alkali metal silica that is tetra methyl orthosilica Carbon Nanofoam CNFs trade name trade name silicate Carbon Nanofoam CNFs slurry carbon electrolyte clustered nanoparticles are achieved by heated or chilled interface 8—Slurry carbon tool steel line in liquid dispersion heated tetra methyl orthosilica, methanol, and Carbon Nanofoam CNFs or liquid dispersion chilled polyvinyl alchohol PVA reinforcement, and Carbon Nanofoams CNFs networks in suspension drying over usually fifteen minutes result network light weight silicate Carbon Nanofoams CNFs controllable, high purity, connectivity, strength, conductivity, and shape. 11. Variable hydraulic preform slurry non ionic or electrolyte silicate carbon nanofoam CNFs extrusion high wear-heat compression resistant light weight insulator or electronic part battery cell ceramic or alkali metal silica colorless and transparent Tetramethyl orthosilica Si(OCH₃)₄ Carbon Nanofoam CNFs trade name silicate Carbon Nanofoam CNFs slurry carbon electrolyte clustered nanoparticles are achieved by heated or chilled interface 8—Slurry carbon tool steel line in liquid dispersion heated Tetramethyl orthosilica Si(OCH₃)₄, methanol MEOH, and Carbon Nanofoam CNFs or liquid dispersion chilled polyvinyl alchohol PVA reinforcement, and Carbon Nanofoams CNFs networks in suspension drying over usually fifteen minutes result network light weight silicate Carbon Nanofoams CNFs controllable, high purity, connectivity, strength, conductivity, and shape. 12. Super Battery construction begins with crucible casted or up to 2.5 phase extrusions highly pure metal or Super Alloy battery cells layered, spaced and casted conductive in series or parallel circuit even or odd interval number combinations varying complex battery cells highly pure acid solid chemical and/or highly pure chemical alkali solid complex crucible casted conductive or up to 2.5 phase extrusions highly pure metal or Super Alloy layered and interval spaced conductive in series or parallel circuit. Super Battery with or without lightweight super impregnated suspension element, Halogen, Antimony, or Chemical Element gases ammonia, nitrogen, hydrogen, hydrochloric acid with or without ionic suspension element carbon nanofoam CNFs and ionic suspension element specification 45 highly pure metals or ionic suspension element specification 46 Super Alloys and/or Alumina, crucible casted conductive or up to 2.5 phase extrusions highly pure metal or Super Alloy layered, and interval spaced series or parallel circuit and/or complex crucible casted conductive or up to 2.5 phase extrusions Variable hydraulic preform slurry non ionic or electrolyte silicate carbon nanofoam CNFs extrusion high wear-heat compression resistant light weight battery cells. Highly pure alkali silica, alumina or elements lithium, cadmium, nickel, lead, copper, specification 45 elements or specification 46 alloys. One by one Super Battery—Each battery cell crucible casted non conductive or submersion bath sealed Thermoplastic synthetic composite polymer insulation control room vacuum protocol manufacture process. Motor frame may be dipped Thermoplastic sealed or synthetic polymer fiber textile mesh, silicate fiber heat resistant textile mesh, Variable hydraulic preform slurry non ionic silicate carbon nanofoam CNFs extrusion high wear-heat compression resistant light weight insulator, and/or high tensile strength Super Carbon Alloy textile shielded mesh. One by one Super Battery—Each battery cell crucible casted or submersion bath sealed Thermoplastic synthetic composite polymer insulator control room vacuum protocol manufacture process. All four conductive or nonconductive heat-wear high tensile strength and compression resistant insulators are designed and built in Monocomb and corrugated—compartmented composite combinations Thermoplastic sealed, layered or woven shielded. 13. Super Motor construction begins with crucible casted or up to 2.5 phase extrusions highly pure metal or Super Alloy composite coils, composite windings, and copper wire drawing, annealing, and spun coils or other highly pure metal including highly pure metal or Super Alloy drawing and annealing process for wire. Super Motors composite coils, composite windings usually copper or Super Alloy includes continuous or numeric interval spools shapes of rod, cylinder, sphere, rectangle, or square crucible casted or up to 2.5 phase extrusions. Super Motor electronic components brushes Carbon Nanofoam CNFs with or without ionic suspension elements each brush alternate carbon nanofoam inductors, and antinode coupler continuous or numeric ramps positive and negative terminal measured in volts and monitors positive and negative terminal measured in volts and negative and negative terminals measured in Ohms of inductor, antinode coupler, and ground series or parallel circuit. Spun numeric copper or Super Carbon Copper Alloy wire may be dipped thermoplastic sealed or synthetic polymer fibers textile shielded mesh, woven silicate heat resistant fibers textile shielded mesh, and high tensile strength carbon nanofoam CNFs Super Alloy shielded textile mesh and motor frame may be dipped thermoplastic sealed or synthetic polymer fiber textile shielded mesh, silicate fiber high heat-resistant insulator textile shielded mesh, and/or high tensile strength Super Carbon Alloy textile shielded mesh. One by one all composite or wire Super—Motor coils and windings are crucible casted or submersion bath sealed Thermoplastic synthetic composite polymer insulator control room vacuum protocol manufacture process. Three heat-wear high tensile strength and Variable hydraulic preform slurry non ionic or electrolyte silicate carbon nanofoam CNFs extrusion high wear-heat compression resistant light weight insulators are designed and built in Monocomb and corrugated—compartmented composite combinations Thermoplastic sealed, layered or woven shielded. Crucible casted or up to 2.5 phase extrusions motor casings, rods, bearings, housings, and assemblies are manufactured and assembled.

3. Preform slurry non ionic or electrolyte making of four sections 14. Preform slurry non ionic or electrolyte carbon nanofoam CNFs extrusion high wear-heat resistant part 15. Preform slurry non ionic or electrolyte carbon nanofoam CNFs extrusion high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 16. Preform slurry non ionic or electrolyte carbon nanofoam CNFs extrusion high wear-heat resistant parts aerospace, automotive, and transportation brake calipers, rotors, pads, and bushings 17. Preform slurry non ionic or electrolyte carbon nanofoam CNFs extrusion high wear-heat resistant parts precision casting molds for the manufacturing of highly pure metal, super alloy, ceramics, acid solid, alkaline, halide, alkalide, nonconductive zirconia, carbon nanofoam CNFs, alternate carbon nanofoam CNFs inductor, or impedance matching load or signal ceramic red brick clay insulator up to 2.5 phase extrusions two to six master preform slurry non ionic or electrolyte carbon nanofoam CNFs extrusion high wear-heat resistant parts precision casting molds.
